(19) United States
(12) Patent Application Publication
(10) Pub. No.: US 2013/0087031 A1
(43) Pub. Date: Apr. 11, 2013

(54) Perforating apparatus

(71) Applicant: Paul Anderson, Upland, CA (US)

(72) Inventor: Paul Anderson, Upland, CA (US)

(21) Appl. No.: 13/200,998

(22) Filed: Oct. 5, 2011

(51) Int. Cl. B26F 1/10; B65H 20/00; B26D 1/26

(52) U.S. Cl. 83/346; 83/660; 83/658; 83/443

(57) ABSTRACT

An apparatus for perforating a length of pierceable material which includes a first roller, the length of pierceable material being in engagement with and at least partially circumscribing said first roller; and a second roller disposed in close proximity to the first roller. The second roller, which is provided with a plurality of piercing members, is movable from a first position wherein the piercing members are spaced apart from the first roller to a second position wherein selected ones of the piercing members pierce the length of pierceable material. Uniquely, the first roller has a plurality of transversely spaced grooves that receive the extremities of the piercing members when the first roller is in the second position.

### CROSS-REFERENCE TO RELATED APPLICATIONS

Not Applicable

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The present invention relates generally to packaging for food products. More particularly, the invention concerns an apparatus for perforating a length of pierceable material that is usable for constructing a package for a food product.

2. Description of Related Art Including Information Disclosed Under 37 CFR 1.97 and 1.98

It is a common practice to package food products, such as loaves of bread and like articles in specially designed, perforated packages. Perforated packages are necessary so that various emissions from the food contained within the package can escape therefrom.

### BRIEF SUMMARY OF THE INVENTION

By way of brief summary, one form of the apparatus for perforating a length of pierceable material comprises a first roller, the length of pierceable material being in engagement with and at least partially circumscribing said first roller; and a second roller disposed in close proximity to the first roller, the second roller having a plurality of piercing members and being movable from a first position wherein the piercing members are spaced apart from the first roller to a second position wherein selected ones of the piercing members pierce the length of piercable material. Uniquely, the first roller has a plurality of transversely spaced grooves that receive the extremities of the piercing members when the first roller is in the second position.

With the foregoing in mind, it is an object of the present invention to provide apparatus that cleanly, efficiently and uniformly pierces a length of piercable material.

Another object of the invention is to provide an apparatus of the character described that pierces a length of piercable material in a manner to avoid tearing or otherwise damaging the material.

Another object of the invention is to provide an apparatus of the aforementioned character that pierces a length of piercable material in a manner to avoid jamming or otherwise damaging the perforating apparatus.

Another object of the invention is to provide an apparatus of the character described that is of a simple, inexpensive and highly reliable construction.

The foregoing objectives, as well as other features and advantages of the present invention, will become readily apparent from the following detailed description and the accompanying drawings.

### BRIEF DESCRIPTION OF SEVERAL VIEWS OF THE DRAWINGS

FIG. 1 is a generally schematic view of a prior art apparatus for perforating a length of pierceable material which is shown here as a length of material for use in constructing a package for packaging bread.

FIG. 2 is a generally schematic view of one form of the apparatus of the present invention for perforating a length of pierceable material, such as a length of material for use in constructing a package for packaging bread.

FIG. 3 is a generally perspective view of one form of the perforating mechanism of the apparatus of the present invention for perforating a length of pierceable material.

FIG. 4 is a top plan view of the portion of the apparatus of the present invention shown in FIG. 3.

FIG. 5 is a side elevational view of the portion of the apparatus of the present invention shown in FIG. 3.

FIG. 6 is an enlarged, fragmentary, generally perspective view of the area designated in FIG. 4 as 6-6.

### DETAILED DESCRIPTION OF THE INVENTION

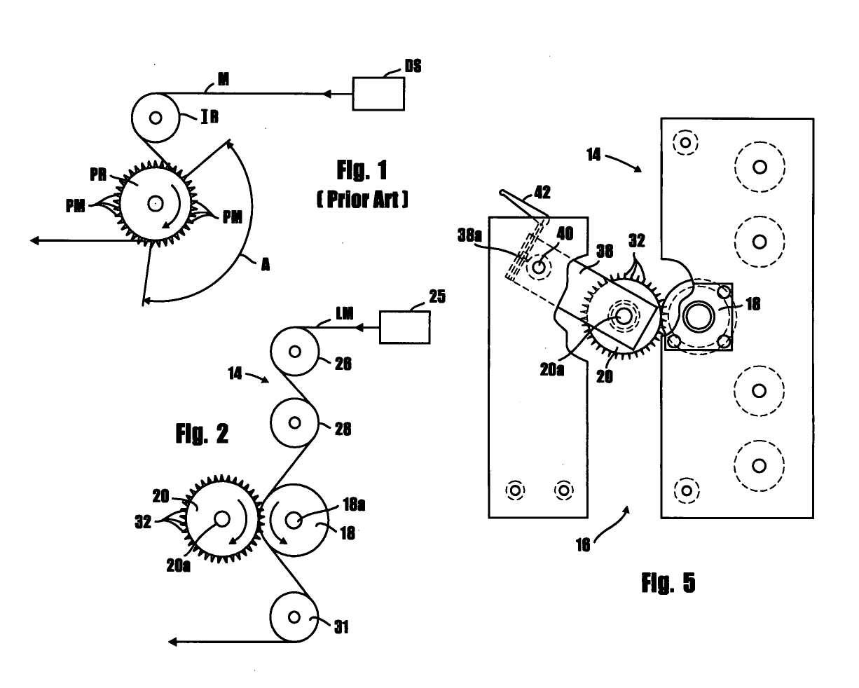

Referring to the drawings and particularly to FIG. 1, a prior art apparatus for perforating a length of pierceable material such as a length of material “M” for use in constructing a package for packaging bread, is there shown. This apparatus comprises a drive system “DS” for controllably moving the length of piercable material around an idler roller “IR” and then around a piercing roller “PR”. Piercing roller “PR” has a plurality of piercing members “PM” that are adapted to pierce the length of piercable material as the material travels around the piercing roller. In FIG. 1 the plurality of piercing members “PM” are shown piercing the length of piercable material in the area of the arc “A”.

This prior art apparatus has proven to be generally ineffective in operation because, as the piercable material travels around the piercing roller, the piercing members “PM” tend to cause creases and tears in the paper and frequently fail to completely penetrate the piercable material. Undesirably, during operation, the creasing and tearing of the paper can cause costly and time-consuming jamming of the perforating apparatus.

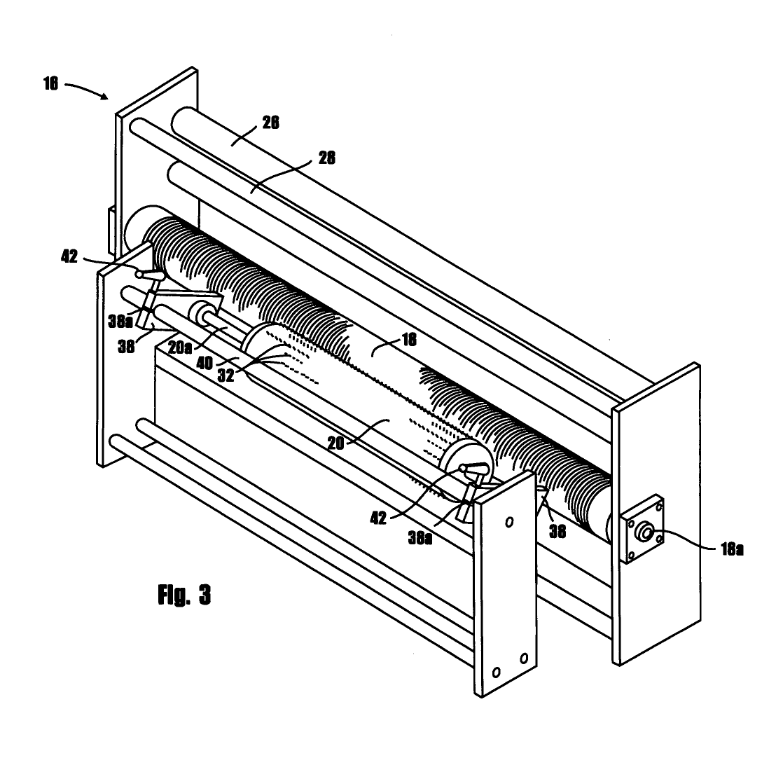

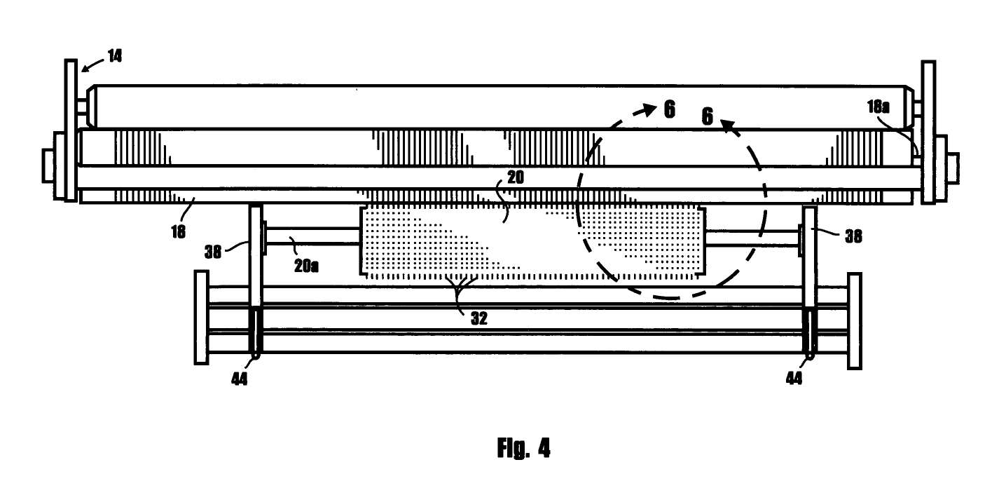

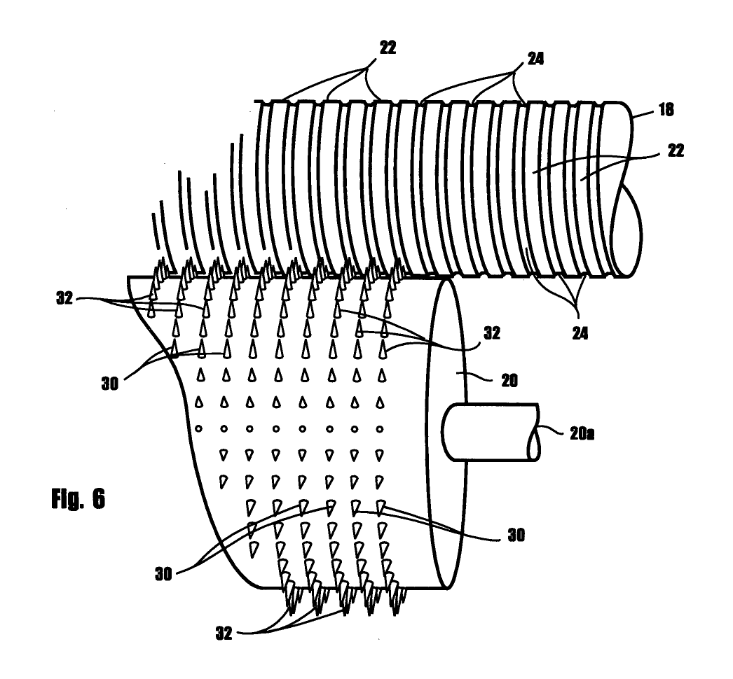

Turning to FIGS. 2 through 6, one form of the apparatus of the present invention for perforating a length of pierceable material, such as a length of material “LM” of the character used in constructing a package for packaging bread, is there shown and generally designated in FIG. 2 by the numeral 14. The apparatus here comprises a support 16 (FIG. 5) and first and second rollers 18 and 20 that are rotatably carried by the support in the manner illustrated in the drawings. As best seen in FIGS. 3 and 6, first roller 18, which is connected to a shaft 18a that is, in turn, connected to support 16 (see FIG. 3), is provided with a plurality of transversely spaced apart ridges 22 that define therebetween a plurality of transversely spaced apart grooves 24. As indicated in the drawings, a second roller 20, which is connected to a perforating shaft 20a that is, in turn, connected to support 16, is positioned in close proximity with first roller 18. The length of material “LM” extends between the first and second rotatable rollers in the manner depicted in FIG. 2 of the drawings. As also depicted in FIG. 2, the apparatus of the invention includes a drive system 24 that is operably associated with the length of piercable material for controllably moving the length of piercable material around idler rollers 26 and 28 that are carried by support 16 (FIG. 3), between the first and second rotatable rollers 18 and 20 and around idler roller 30 that is also carried by support 16. The length of pierceable material is entrained about rollers 26 and 28 in the manner shown in FIG. 2.

As illustrated in FIG. 6 of the drawings, second rotatable roller 20 is provided with a plurality of transversely spaced apart rows 30 of piercing members 32. In order to accomplish the piercing operation, roller 20 is movable from a first position wherein piercing members 32 are spaced apart from said first rotatable roller 18 to the second position shown in FIGS. 2 through 6 wherein selected ones of said piercing members pierce the length of piercable material and extend into the grooves 22 formed in first rotatable roller 18. As illustrated in FIGS. 5 and 6, roller 20 is rotatably mounted on the previously mentioned first shaft 20a that is connected proximate its extremities to a pair of transversely spaced support plates 38 that are provided with longitudinally extending slits 38a. Support plates 38 are, in turn, rotatably connected to a support plate shaft 40 that is connected proximate its extremities to support 16. Connected to each of the support plates 38 is a tightening member 42 that can be used to clamp support plates 38 to support plate shaft 40 when rotatable roller 20 is the second position shown in FIG. 5. More particularly, as shown in FIG. 3, when the tightening members 42, which are threadably connected to each of the support plates 38, are in a retracted position, slits 38a are open so as to allow the support plates 38, along with rotatable roller 20, to rotate about support plate shaft 40. However, when rotatable roller 20 is in the second position shown in FIG. 5, the tightening member 42 can be tightened in a manner to close slits 38a and thereby prevent rotation of the support plates 38 relative to support plate shaft 40 which, in turn, will lock the rotatable roller 20 in its second position.

During operation of the apparatus, as the length of material “LM” is being pierced it engages and is uniformly supported by the transversely spaced apart ridges 22 of rotatable roller 18. It is this unique feature of the invention which insures that, as the length of piercable material passes between the first and second rotatable rollers 18 and 20, the material is cleanly and uniformly pierced in a manner to avoid tearing or otherwise damaging the material. Because the material is being cleanly and uniformly pierced, costly and time-consuming jamming of the perforating apparatus due to material creases and tearing is also avoided.

Having now described the invention in detail in accordance with the requirements of the patent statutes, those skilled in this art will have no difficulty in making changes and modifications in the individual parts or their relative assembly in order to meet specific requirements or conditions. Such changes and modifications may be made without departing from the scope and spirit of the invention, as set forth in the following claims.

1. An apparatus for perforating a length of pierceable material comprising:
(a) a first roller, the length of pierceable material being in engagement with and at least partially circumscribing said first roller; and
(b) a second roller disposed in close proximity to said first roller, said second roller having a plurality of piercing members and being movable from a first position wherein said piercing members are spaced apart from said first roller to a second position wherein selected ones of said piercing members pierce the length of piercable material.

2. The apparatus as defined in claim 1 in which said first roller has a plurality of grooves constructed and arranged to receive said piercing members when said second roller is in said second position.

3. The apparatus as defined in claim 1 further including a drive system operably associated with the length of piercable material for controllably moving the length of piercable material between said first and second rollers.

4. The apparatus as defined in claim 1 further including a support, said first and second rollers being rotatably carried by said support.

5. The apparatus as defined in claim 4 further including a plurality of idler rollers carried by said support, said length of pierceable material being entrained about said plurality of idler rollers.

6. An apparatus for perforating a length of pierceable material comprising:
(a) a support;
(b) a first roller rotatably carried by said support, said first roller having a plurality of transversely spaced apart ridges defining a plurality of transversely spaced apart grooves;
(c) a second roller rotatably carried by said support in close proximity with said first rotatable roller, the length of piercable material extending between said first and second rotatable rollers, said second rotatable roller having a plurality of transversely spaced apart rows of piercing members and being movable from a first position wherein said piercing members are spaced apart from said first rotatable roller to a second position wherein selected ones of said piercing members pierce the length of piercable material and extend into said grooves of said first rotatable roller.

7. The apparatus as defined in claim 6 further including a drive system operably associated with the length of piercable material for controllably moving the length of piercable material between said first and second rotatable rollers.

8. The apparatus as defined in claim 6 further including a plurality of idler rollers carried by said support, said length of pierceable material being entrained about said plurality of idler rollers.

9. An apparatus for perforating a length of pierceable material comprising:
(a) a support;
(b) a first roller rotatably carried by said support, said first roller having a plurality of transversely spaced apart ridges defining a plurality of transversely spaced apart grooves;
(c) a second roller rotatably carried by said support in close proximity with said first rotatable roller, the length of piercable material extending between said first and second rotatable rollers, said second rotatable roller having a plurality of transversely spaced apart rows of piercing members and being movable from a first position wherein said piercing members are spaced apart from said first rotatable roller to a second position wherein selected ones of said piercing members pierce the length of piercable material and extend into said grooves of said first rotatable roller; and
(d) a drive system operably associated with the length of piercable material for controllably moving the length of piercable material between said first and second rotatable rollers.

10. The apparatus as defined in claim 9 further including a plurality of idler rollers carried by said support, said length of pierceable material being entrained about said plurality of idler rollers.

11. The apparatus as defined in claim 9 in which said second rotatable roller is connected to a perforating shaft and in which said apparatus further includes pair of transversely spaced support plates connected to said perforating shaft and also being rotatably connected to a support plate shaft, each of said support plates of said pair of transversely spaced support plates being provided with a longitudinally extending slit.

12. The apparatus as defined in claim 11 in which said apparatus further includes a tightening member connected to each of said transversely spaced support plates for closing said slits to clamp said support plates to said support plate shaft.
